(19) United States
(12) Patent Application Publication
(10) Pub. No.: US 2025/0358789 A1
(43) Pub. Date: Nov. 20, 2025

(54) TECHNOLOGIES FOR AMBIENT INTERNET OF THINGS COMMUNICATIONS

(71) Applicant: Apple Inc., Cupertino, CA (US)

(72) Inventors: Vivek G. Gupta, San Jose, CA (US); Alexander Sirotkin, Tel Aviv (IL); Haijing Hu, Los Gatos, CA (US); Naveen Kumar R. Palle Venkata, San Diego, CA (US); Sudeep Manithara Vamanan, Nuremberg (DE); Zhibin Wu, Los Altos, CA (US)

(73) Assignee: Apple Inc., Cupertino, CA (US)

(21) Appl. No.: 19/181,205

(22) Filed: Apr. 16, 2025

Related U.S. Application Data
(60) Provisional application No. 63/648,603, filed on May 16, 2024.

(51) Int. Cl. H04W 68/02; H04W 12/06; H04W 60/04; H04W 74/0833

(52) U.S. Cl. CPC H04W 68/02; H04W 12/06; H04W 60/04; H04W 74/0833

(57) ABSTRACT

The present application relates to devices and components including apparatus, systems, and methods for ambient Internet of things (AIoT) operation in communication networks.

### CROSS-REFERENCE TO RELATED APPLICATION

This application claims the benefit of U.S. Provisional Patent Application No. 63/648,603, filed May 16, 2024. The disclosure of this application is incorporated by reference herein in its entirety.

### TECHNICAL FIELD

This application relates generally to wireless networks and, in particular, to technologies for ambient Internet-of-things (AIoT) communications in wireless networks.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates two topologies for components of the network environment in accordance with some embodiments.

FIG. 3 illustrates an ambient Internet of things (AIoT) architecture in accordance with some embodiments.

FIG. 4 illustrates control-plane protocol stacks of components of the network environment in accordance with some embodiments.

FIG. 5 illustrates a signaling diagram in accordance with some embodiments.

FIG. 6 illustrates another signaling diagram in accordance with some embodiments.

FIG. 7 illustrates another AIoT architecture in accordance with some embodiments.

FIG. 8 illustrates another signaling diagram in accordance with some embodiments.

FIG. 9 illustrates control-plane protocol stacks of components of the network environment in accordance with some embodiments.

FIG. 10 illustrates an operation flow/algorithmic structure in accordance with some embodiments.

FIG. 11 illustrates another operation flow/algorithmic structure in accordance with some embodiments.

FIG. 12 illustrates another operation flow/algorithmic structure in accordance with some embodiments.

FIG. 13 illustrates a device in accordance with some embodiments.

FIG. 14 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated.

Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

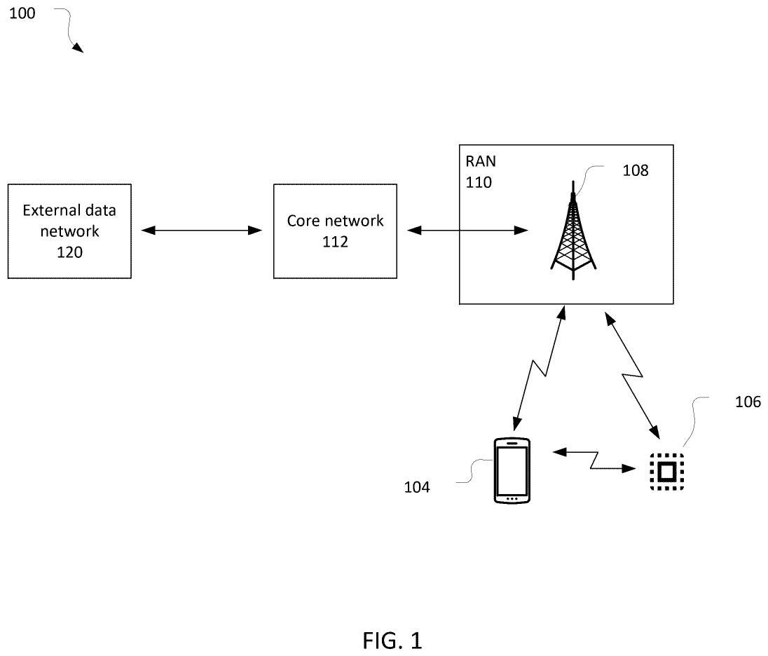

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

The network environment 100 may further include a core network 112. The core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions with, for example, an external data network 120.

Generic reference herein to a “network” may refer to one or more components of the RAN 110, core network 112, or external data network 120.

In some embodiments, the network environment 100 may also include an AIoT device 106. The AIoT device 106 may also be referred to as a tag. The AIoT device 106 may be a low-complexity, low-power consumption device with limited or no energy storage capabilities. The AIoT device 106 may depend on various ambient energy sources. For example, the AIoT device 106 may obtain energy from sources such as, but not limited to, radio-frequency signals, solar, kinetic/vibration, electromagnetic, electrostatic, thermal energy, thermoelectric, magnetic, wind, water, or acoustic sources. In some embodiments, the AIoT device 106 may be similar to that described in Third Generation Partnership Project (3GPP) Technical Report (TR) 38.848 v18.0.0 (2023-09-29).

The AIoT device 106 may communicate with another device, which may be referred to as a reader, to perform various inventory, sensor, positioning, command operations. The reader may be an intermediate node, for example, the UE 104, or a node of the RAN 110, for example, the base station 108.

The AIoT device 106 may be a Type 1 device or a Type 2 device. A Type 1 device may have: a peak power consumption of approximately 1 μW; energy storage; an initial sampling frequency offset (SFO) of up to 10^{x} parts per million (PPM); and neither downlink nor uplink amplification. Uplink transmission from a Type 1 device may be performed by backscattering a carrier wave (CW) provided by another device. A Type 2 device may have: a peak power consumption of less than or equal to a few hundred μW; energy storage; an initial SFO up to 10^{X} ppm; and downlink or uplink amplification. A Type 2 device that generates an uplink transmission by backscattering a CW provided by another device may be referred to as a Type 2a device, while a Type 2 device that generates an uplink transmission internally may be referred to as a Type 2b device. In some embodiments, the coverage design target for the AIoT device may be up to a maximum of 10-50 meters.

Service aspects associated with the AIoT device 106 may include communication aspects, positioning/location of the AIoT device 106, management, information collection and network capability exposure, charging, security, and privacy.

The AIoT device 106 may be used in a variety of indoor/outdoor use cases. The use cases may be inventory use cases or command use cases. Examples of inventory use cases may include: automated warehousing, automobile manufacturing, medical instruments inventory management, airport terminal/shipping port, smart laundry, automated supply chain distribution, fresh food supply chain, etc. Examples of command use cases may include: online modification of medical instruments status, device activation and deactivation, elderly health care, device permanent deactivation, electronic shelf label, agricultural controller etc. The AIoT device 106 may additionally/alternatively be employed with respect to other use cases.

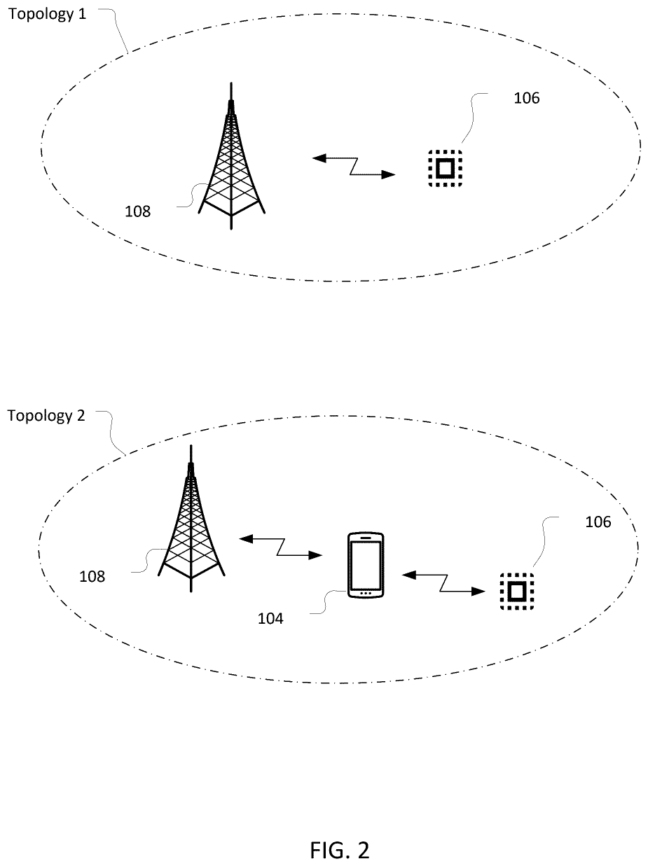

FIG. 2 illustrates components of the network environment 100 in various topologies in accordance with some embodiments.

In Topology 1, the base station 108 operates as the reader and communicates directly and bidirectionally with the AIoT device 106. AIoT data/signaling may be transmitted in the uplink or the downlink. In some instances, the base station transmitting to the AIoT device 106 may be different from a base station receiving from the AIoT device 106. In Topology 1, the base station 108 and the AIoT device 106 may both be co-located at a site, for example, both may be indoors. The base station 108 may provide a microcell in these embodiments.

In Topology 2, the AIoT device 106 may communicate bidirectionally with the UE 104, which operates as the reader. The UE 104 may be coupled with the base station 108 and may be under network control for purposes of AIoT operations. AIoT data/signaling may be exchanged over an AIoT interface between the UE 104 and the AIoT device 106 and over a Uu interface between the UE 104 and the base station 108. In Topology 2, the UE 104 may also be referred to as an intermediate node, which may be a device such as a mobile phone, a relay, an integrated access and backhaul (IAB) node, a repeater, a dedicated reader, etc. The UE 104 and the AIoT device may both be located indoors, while the base station 108 is located outdoors.

There may be three types of application-layer traffic with respect to AIoT communications: device terminated (DT), device originated (DO)-DT triggered, and DO-autonomous (DO-A).

DT traffic may be relevant to a command use case in which the reader sends a command to the AIoT device 106. The reader, for example, the UE 104 or the base station 108, sends a transmission in the downlink channel. No external CW generation is needed, nor is there a need for access stratum (AS) layer acknowledgment. AS layer transmission may be triggered by a core network (CN)-initiated message in Topology 1, or upper layers of UE 104 or CN-initiated message in Topology 2.

DO-DTT may be relevant to an inventory use case. Application layer transactions may be bidirectional, for example, from reader to AIoT device 106 or from AIoT device 106 to the reader. The lower-layer transmission scheme may rely on a backscattered CW (in which case external CW generation may be needed) or an internally generated CW (in which case no external CW generation is needed). AS layer acknowledgment may not be needed. The AS layer transmission may be triggered by a processed DT trigger or DO traffic being generated and available.

DO-A may be relevant to a sensor use case. Application layer transactions may be from the AIoT device 106 to the reader. In some cases, the transmissions may be autonomous. The lower-layer transmission scheme may rely on a backscattered CW (in which case external CW generation may be needed) or an internally generated CW (in which case no external CW generation is needed). The AS layer transmission may be triggered when the upper layer of the AIoT device 106 has made DO traffic available. There may be some restrictions of AS layer triggering in some instances.

Embodiments of the present disclosure describe system architecture aspects for AIoT communication in the network environment 100. Various aspects describe: device subscription and identification; AIoT device registration and connection with core network 112; security framework used to connect the AIoT device 106 with the core network 112; how data transfer is done between an application function and the AIoT device 106 for different service operations like inventory and command; operations performed by the AIoT device 106 for different service operations; security requirements for the AIoT device 106; and network impacts for supporting the AIoT device 106.

Given the large number of configurations/types of devices available for different applications, two device configurations are presented herein with respect to the AIoT device 106. These two device configurations may be suitable for Topology 1 or Topology 2.

A first configuration may be suitable for ultra-low complexity devices with ultra-low power consumption for very low in AIoT applications with limited or no energy storage capabilities (for example, AIoT Type 1 devices). The AIoT device 106 having the first configuration may be referred to as low-end AIoT device 106_1.

The low-end AIoT device 106_1 may not have a universal integrated circuit card (UICC). Instead, the low-end AIoT device 106_1 may be preconfigured with a device identifier (ID). The low-end AIoT device 106_1 may be preconfigured with the device ID by having the device ID embedded or provisioned into a component of the low-end AIoT device 106_1. This may be done at the time the component is manufactured or another time before the low-end AIoT device 106_1 is ultimately put into service. The device ID may be known to the core network 112. The low-end AIoT device 106_1 may support DT, DO-DTT, or DO-A communications.

The low-end AIoT device 106_1 may not perform a device registration with the core network 112, nor will the low-end AIoT device 106_1 authenticate with the network.

The low-end AIoT device 106_1 may not have traditional non-access stratum (NAS) states (for example, registered or deregistered) or radio resource control (RRC) states (for example, idle, inactive, or connected states). Further, mobility or handover operations may not be supported by the low-end AIoT device 106_1; however, the low-end AIoT device 106_1 may be paged as will be described further herein.

The low-end AIoT device 106_1 may communicate with the network directly by sending data using its device ID. The data may be of an Ethernet type or unstructured type. In some embodiments, a protocol data unit (PDU) session may be created for communications between the low-end AIoT device 106_1 and the network. The data transfer may be accomplished using NAS messages.

In some embodiments, transmission of the data may be encrypted using a shared key between the low-end AIoT device 106_1 and the network. The low-end AIoT device 106_1 may be pre-provisioned with one or more of the shared keys to avoid the complexity required to dynamically generate the keys. In some embodiments, there may be minimal or no secure communications between the low-end AIoT device 106_1 and the network.

A second configuration may be suitable for relatively low-complexity, low-power devices with limited energy storage capabilities (for example, AIoT Type 2 devices). These devices may generate their own uplink transmissions (for example, AIoT Type 2b devices) or may rely on externally provided CW (for example, AIoT Type 2a devices). The AIoT device 106 having the second configuration may be referred to as high-end AIoT device 106_2.

The high-end AIoT device 106_2 may have a UICC. The high-end AIoT device 106_2 may register with the network and the network may authenticate the device and assign the device with temporary credentials for further communication. The communication between the high-end AIoT device 106_2 and the network is secure, for example, the communication may be encrypted and integrity protected. DT, DO-DTT, DO-A communication may be supported.

The high-end AIoT device 106_2 may have some notion NAS states (for example, registered or deregistered) or RRC states (for example, idle, inactive, or connected states). These states may be similar to states used for UE connectivity with respect to existing networks, or may be a subset thereof. Further, mobility or handover operations may not be supported by the high-end AIoT device 106_2; however, the high-end AIoT device 106_2 may be paged as will be described further herein.

In some embodiments, the high-end AIoT device 106_2 may initiate PDU session establishment for data transfer. The data may be transferred using control plane (for example, NAS messages) or user plane. The data may be of an Internet protocol (IP) type, Ethernet type, or unstructured type. Data transfer using other higher-layer (for example, layer 3 (L3) or higher) AIoT protocols may additionally/alternatively be supported by the high-end AIoT device 106_2.

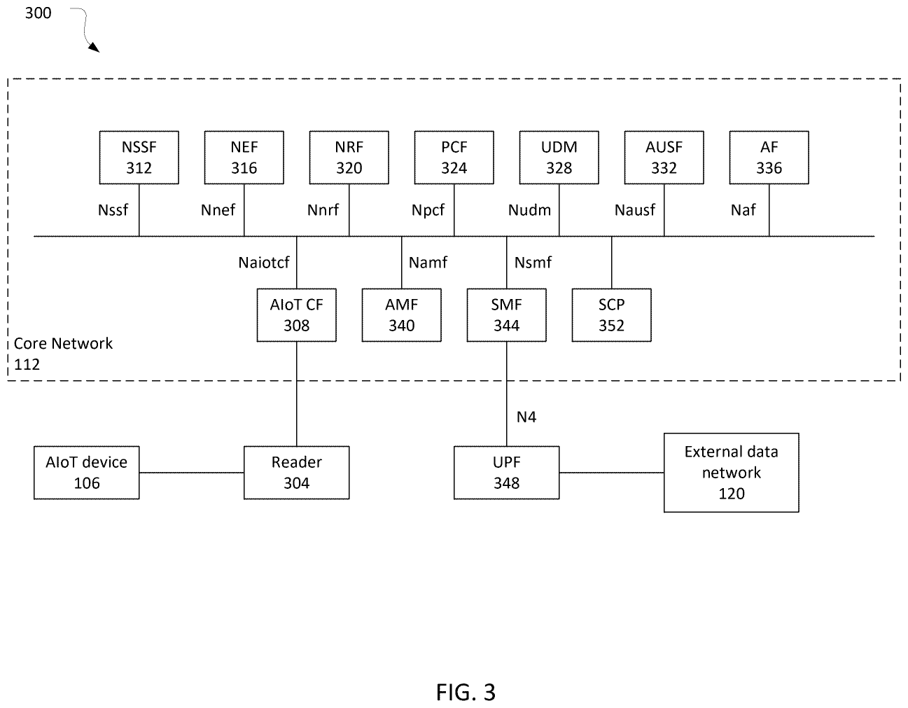

FIG. 3 illustrates an AIoT architecture 300 of the network environment 100 in accordance with some embodiments. The AIoT architecture 300 may correspond to Topology 1 and it may apply to communications with respect to both Type 1 and Type 2 devices.

The AIoT architecture 300 may include the AIoT device 106 coupled with a reader 304. The reader 304 may be part of the RAN 110, for example, the base station 108.

The reader 304 may be coupled with an AIoT control function (CF) 308 of the core network 112. The AIoT CF 308 may be responsible for managing AIoT communications with the AIoT device 106. The AIoT CF 308 may have an Naiotcf interface exposed to other control functions of the core network 112. The other control functions of the core network 112 may be described as follows.

A network slice selection function (NSSF) 312 may provides an Nssf interface for communication with other network functions. The NSSF 312 may manage network slice selection.

A network exposure function (NEF) 316 may provide an Nnef interface for communication with other network functions. The NEF 316 may expose capabilities and events of the core network 112 to application functions within the core network 112 and to the external data network 120.

A network repository function (NRF) 320 may provide an Nnrf interface for communication with other network functions. The NRF 320 may assist other network functions with registration services.

A policy control function (PCF) 324 may provide an Npcf interface for communication with other network functions. The PCF 324 may provide policies associated with mobility or session management control.

A unified data management function (UDM) 328 may provide an Nudm interface for communication with other network functions. The UDM 328 may manage and store subscriber data. The UDM 328 may work with an authentication services function (AUSF) 332 to facilitate various network and subscriber authentication processes. The AUSF 332 may provide an Nausf interface for communication with other network functions.

An application function (AF) 336 may provide an Naf interface for communication with other network functions. The AF 336 may act as an application server to consume or provide application data and related signaling.

An access and mobility management function (AMF) 340 may provide an Namf interface for communication with other network functions. The AMF 340 may provide various registration, connection, reachability, and mobility management functions. In some embodiments, the AMF 340 and AIoT CF 308 may be integrated into one network node/function.

A session management function (SMF) 344 may provide an Nsmf interface for communication with other network functions. The SMF 344 may provide PDU session management, IP address allocation, GTP-U tunnel management, and downlink notification management. The SMF 344 may be coupled with a user plane function (UPF) 348 over an N4 reference point. The UPF 348 may manage the routing and forwarding of user plane packets between the base station 108 and the external data network 120

A service communication proxy (SCP) 352 may provide an Nscp interface for communication with other network functions. The SCP 352 may facilitate management of services and communications between various network functions within the core network 112.

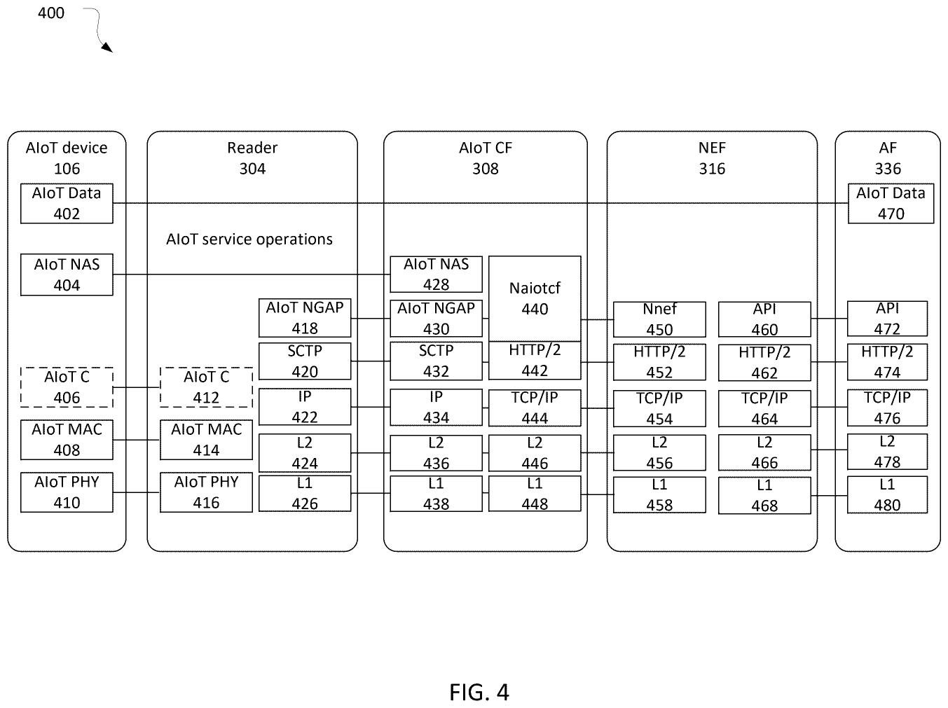

FIG. 4 illustrates control-plane protocol stacks of components of the network environment 100 in accordance with some embodiments.

The AIoT device 106 may include the following layers: AIoT data 402; AIoT NAS 404; an AIoT control (AIoT C) 406; AIoT media access control (MAC) 408; and AIoT physical (PHY) 410.

The reader 304 may include the following layers: AIoT C 412; AIoT MAC 414; AIoT PHY 416; AIoT next generation application protocol (NGAP) 418; stream control transmission protocol (SCTP) 420; IP 422; Layer 2 (L2) 424; and Layer 1 (L1) 438. The AIoT PHY 416 may be communicatively coupled with AIoT PHY 410, the AIoT MAC 414 may be communicatively coupled with AIoT MAC 408; and AIoT C 412 may be communicatively coupled with AIoT C 406.

The AIoT CF 308 may include the following layers: AIoT NAS 428; AIoT NGAP 430; SCTP 432; IP 434; L2 436; L1 438; Naiotcf 440; hypertext transfer protocol version 2 (HTTP/2) 442; transmission control protocol (TCP)/IP 444; L2 446; and L1 448. The AIoT NGAP 430 may be communicatively coupled with AIoT NGAP 418; the SCTP 432 may be communicatively coupled with SCTP 420; IP 434 may be communicatively coupled with IP 422; L2 436 may be communicatively coupled with L2 424; and L1 438 may be communicatively coupled with L1 426.

The NEF 316 may include the following layers: Nnef 450; HTTP/2 452; TCP/IP 454; L2 456; L1 458; application programming interface (API) 460; HTTP/2 462; TCP/IP 464; L2 466; and L1 468. The Nnef 450 may be communicatively coupled with Naiotcf 440; HTTP/2 452 may be communicatively coupled with HTTP/2 442; TCP/IP 454 may be communicatively coupled with TCP/IP 444; L2 456 may be communicatively coupled with L2 446; and L1 458 may be communicatively coupled with L1 448.

The AF 336 may include the following layers: AIoT data 470; API 472; HTTP/2 474; TCP/IP 476; L2 478; and L1 480. The AIoT data 470 may be communicatively coupled with AIoT data 402; API 472 may be communicatively coupled with API 460; HTTP/2 474 may be communicatively coupled with HTTP/2 462; L2 478 may be communicatively coupled with L2 466; and L1 480 may be communicatively coupled with L1 468.

Except as otherwise described herein, the layers of the control-plane protocol stacks of FIG. 4 may be similar to like-named layers of existing cellular communication networks as defined by relevant 3GPP Technical Specifications.

AIoT data may be transferred between the AIoT Data 402 and AIoT data 470 via an end-to-end connection. Transfer of the AIoT data between the AIoT device 106 and the AIoT CF 308 may be through NAS messages conveyed between AIoT NAS 404 and AIoT NAS 428. This may be the case for Topology 1, for example. In some instances, the reader 304 may be capable of receiving AIoT data via AIoT C 412 from AIoT C 406 and encapsulating the AIoT data packets into NGAP (or its equivalent). In this case, the AIoT NAS may not be needed at all.

In some embodiments, the AIoT C 406/412 may be omitted entirely.

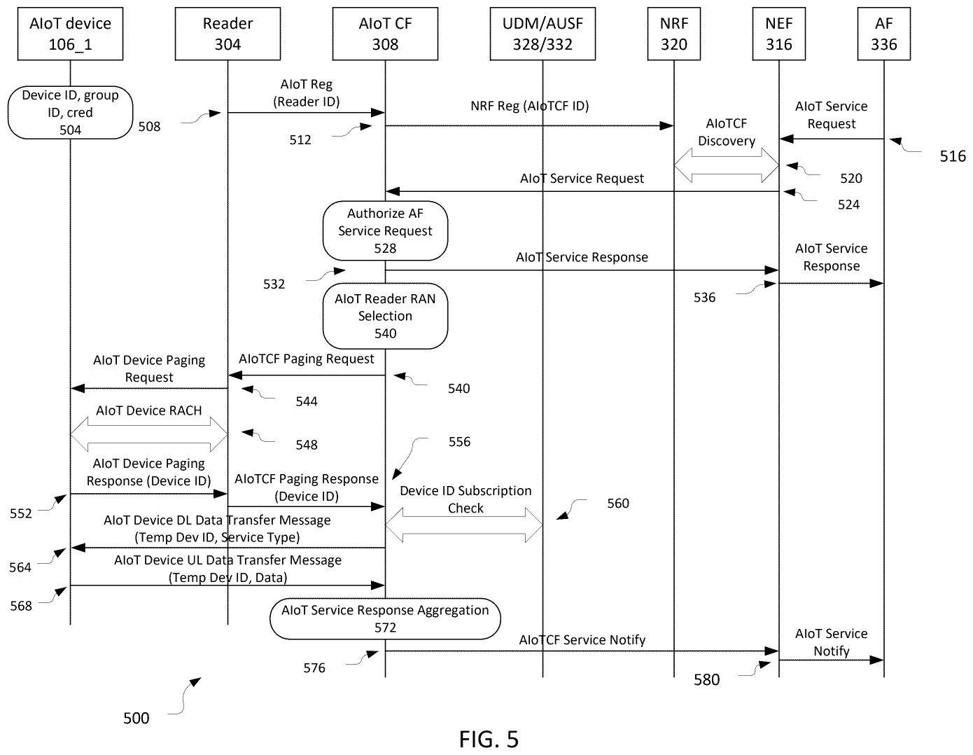

FIG. 5 illustrates a signaling diagram 500 between various components of the network environment 100 in accordance with some embodiments. The signaling diagram 500 may correspond to AIoT service information flow for AIoT 106_1 for topology 1.

At 504, the AIoT 106_1 may be preconfigured with a device ID. In some embodiments, the AIoT 106_1 may be preconfigured with additional/alternative information including, for example, a group ID, credentials, or keys.

At 508, the reader 304 may generate and send an AIoT registration message to the AIoT CF 308. The AIoT registration message may include the reader ID.

The signaling diagram 500 may further include, at 512, the AIoT CF 308 generating and transmitting an NRF registration message to the NRF 320. The NRF registration message may be generated to include an ID associated with the AIoT CF 308 (AIoT CF ID).

The signaling diagram 500 may further include, at 516, the AF 336 generating and sending an AIoT service request to the NEF 316. The AIoT service request may be for a specific service operation such as, for example, gathering inventory or sending a command.

The signaling diagram 500 may further include, at 520, the NEF 316 working with the NRF 320 to perform an AIoT CF discovery to discover the AIoT CF 308. As part of the AIoT CF discovery operation, the NRF 320 may provide the NEF 316 with information about the AIoT CF 308 and, potentially, other devices (for example, the low-end AIoT device 106_1 or the reader 304).

With information about the AIoT CF 308, the NEF 316 may generate and send an AIoT service request to the AIoT CF 308 at 524.

The AIoT CF 308 may, upon receiving the AIoT service request, attempt to authorize the AF service request at 528. The AIoT CF 308 may, at 532, generate and send an appropriate AIoT service response to the NEF 316 based on the authorization attempt. The NEF 316 may forward the AIoT service response to the AF 336 at 536.

The signaling diagram may further include, at 540, the AIoT CF 308 generating and sending an AIoT CF paging request to the reader 304 as part of a process to discover the appropriate reader to perform services associated with the AIoT service request. The reader 304 may, in turn, generate and send an AIoT device paging request at 544. The AIoT device paging request may be specific to the low-end AIoT device 106_1, specific to a group of AIoT devices, or generic to any AIoT device.

The signaling diagram 500 may further include, at 548, the AIoT device 106 performing an AIoT device random access channel (RACH) with the reader 304.

Following the AIoT device RACH, the low-end AIoT device 106_1 may generate and send an AIoT device paging response message to the reader 304. The AIoT device paging response message may be generated to include the device ID. In some embodiments, the AIoT device paging response message may include additional/alternative information preconfigured at the low-end AIoT device 106_1.

The signaling diagram 500 may further include, at 556, the reader 304 generating an AIoT CF paging response based on the AIoT device paging response. The AIoT CF paging response may be responsive to the AIoT CF paging request received at 540. The AIoT CF paging response may be transmitted to the AIoT CF 308 at 556.

The signaling diagram 500 may further include, at 560, the AIoT CF 308 performing a device ID subscription check with the UDM 328 or AUSF 332. The device ID subscription check may be used to verify whether the low-end AIoT device 106_1 is enabled or disabled, a service area of the low-end AIoT device 106_1, or service operations that may be performed by the low-end AIoT device 106_1. In some embodiments, the AIoT CF 308 may be provided with device subscription information (from the UDM 328 or AUSF 332) that the AIoT CF 308 uses to verify service aspects associated with the low-end AIoT device 106_1. In other embodiments, the UDM 328 or AUSF 332 may provide an indication of the verified service aspects associated with the low-end AIoT device 106_1.

In some embodiments, if the AIoT CF 308 or other components of the network environment 100 determine that the integrity of the low-end AIoT device 106_1 is compromised, the device ID may be added to a blacklist that is maintained by a public land mobile network (PLMN).

The signaling diagram 500 may further include, at 564, the AIoT CF 308 generating and sending an AIoT device downlink (DL) data transfer message to the low-end AIoT device 106_1. The AIoT device DL data transfer message may include a temporary device ID and an indication of a service type associated with the AF service request (for example, an inventory request, a command, etc.). The temporary device ID may be assigned to the low-end AIoT device 106_1 by the AIoT CF 308 and may be used for purposes of responding to a specific request or a plurality of requests. In some embodiments, the temporary ID may be assigned by the reader 304 or by the low-end AIoT device 106_1 itself.

The signaling diagram 500 may further include, at 568, the low-end AIoT device 106_1 generating and sending an AIoT device uplink (UL) data transfer message to the AIoT CF 308. The AIoT device UL data transfer message may include the temporary device ID and data associated with the AF service request.

In some embodiments, the data transmission between low-end AIoT device 106_1 and the network may be encrypted using keys shared between the low-end AIoT device 106_1 and network. The data can be of an Ethernet or unstructured type. There may be no need to establish any PDU session and the data can be directly sent over the AIoT NAS control plane. In some embodiments, data transfer using other higher layer (L3+) AIoT protocol may also be supported wherein the UPF 348 may parse the AIoT header to extract the device ID to know how to route packets.

While the messages 564 and 568 show communication starting in the downlink direction, in other embodiments, the communication may start in the uplink direction.

In some embodiments, the content from the AIoT device DL data transfer message (for example, temporary device identifier and service type) may be included in the paging requests transmitted at 540 and 544; the content from the AIoT device UL data transfer message (for example, temporary device identifier and data) may be included in the paging response messages at 552 and 556.

The signaling diagram 500 may further include, at 572, the AIoT CF 308 performing an AIoT service response aggregation. For example, the AIoT CF 308 may collect data from a plurality of AIoT devices 106_1 related to the AF service request.

The signaling diagram 500 may further include, at 576, the AIoT CF 308 generating and sending an AIoT CF service notify message to the NEF 316. The AIoT CF service notify message may include the data from the low-end AIoT device 106_1 (and potentially other AIoT devices) that is responsive to the AIoT service request. The NEF 316 may forward the AIoT service notify message to the AF 336 at 580.

While the signaling diagram 500 illustrates the AF initiating the AIoT service information flow, in other embodiments, the flow may be initiated by the low-end AIoT device 106_1.

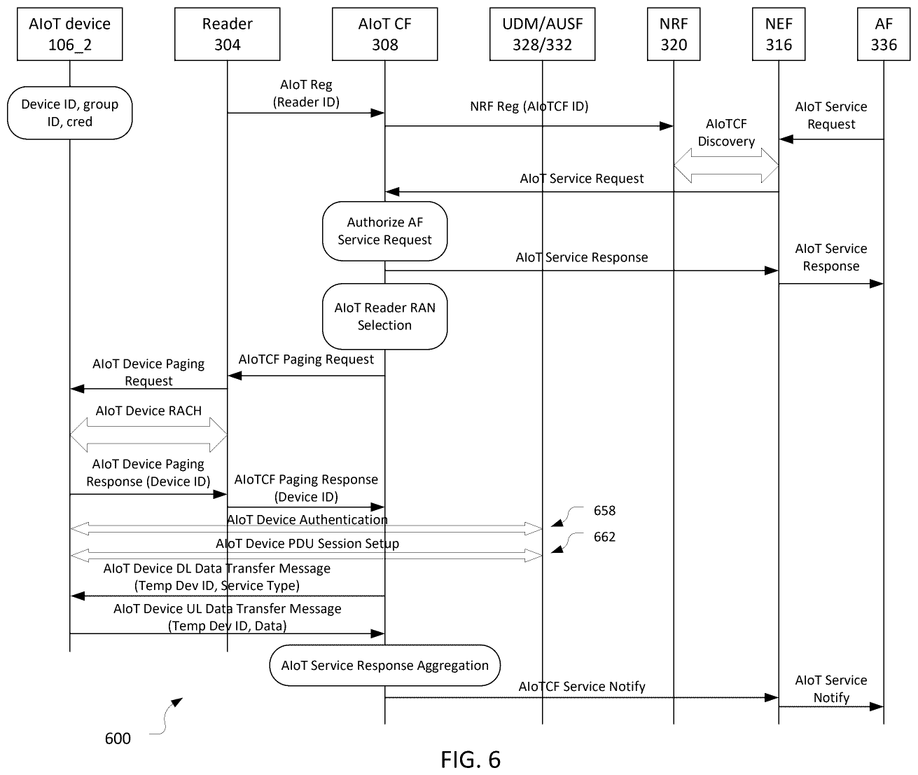

FIG. 6 illustrates a signaling diagram 600 between various components of the network environment 100 in accordance with some embodiments. The signaling diagram 600 may correspond to AIoT service information flow for AIoT 106_2 for topology 1.

The signaling diagram 600 may include operations and signals similar to those described with respect to signaling diagram 500. However, instead of the AIoT CF 308 performing a device ID subscription check, the signaling diagram 600 may include the high-end AIoT device 106_2 performing an AIoT device authentication with the AIoT CF 308, UDM 328, or the AUSF 332 at 658. In some embodiments, the authentication may be part of an AIoT device registration procedure, which may be similar in some respects to a traditional 5th Generation System (5GS) registration procedure. The high-end AIoT device 106_2 may generate and send a registration request message to the AIoT CF 308 or AMF 340. The registration request message may provide an indication of AIoT support in a mobility management capability. A subscription for the high-end AIoT device 106_2 may be enhanced to indicate whether the high-end AIoT device 106_2 supports AIoT operation. A registration accept message may be enhanced to indicate whether the high-end AIoT device 106_2 has been authenticated to perform AIoT operation. In some embodiments, the registration accept message may include the temporary device ID assigned to the high-end AIoT device 106_2 for subsequent communication. The temporary device ID may survive a plurality of energy harvesting cycles, which may be enabled by storage capabilities of the high-end AIoT device 106_2. Once registration of the high-end AIoT device 106_2 is successful, the high-end AIoT device 106_2, may be in a registered state.

Following authentication, the signaling diagram 600 may include the high-end AIoT device 106_2 creating a PDU session for data transfer by performing a PDU session setup at 662. With the PDU session setup, the data of an IP type, Ethernet type, or unstructured type may be transferred. Data transfer can take place using user plane as well.

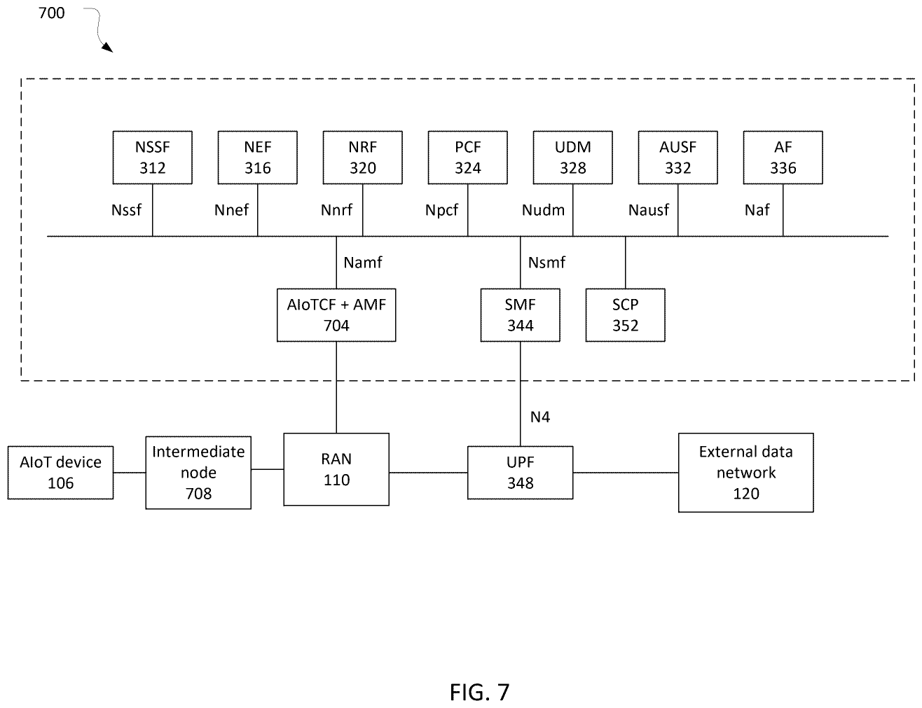

FIG. 7 illustrates an AIoT architecture 700 of the network environment 100 in accordance with some embodiments. The AIoT architecture 700 may correspond to Topology 2.

In general, the AIoT architecture 700 may be similar to AIoT architecture 300. However, the AIoT architecture 700 may include AIoT CF+AMF 704 combined in a single node. Further, AIoT architecture 700 includes intermediate node 708 communicatively coupled with and between the RAN 110 and the AIoT device 106. The intermediate node 708 may be, for example, the UE 104. The RAN 110 may be communicatively coupled with both the AIoT CF+AMF 704 and the UPF 348.

Data transfer using the control plane may go from the AIoT device 106, to the intermediate node 708, to the RAN 110, to the AIoT CF+AMF 704, to the SMF 344, to the UPF 348, and to the external data network 120 (or vice versa in the downlink direction).

Data transfer using the user plane may go from the AIoT device 106, to the intermediate node 708, to the RAN 110, to the UPF 348, to the external data network 120 (or vice versa in the downlink direction).

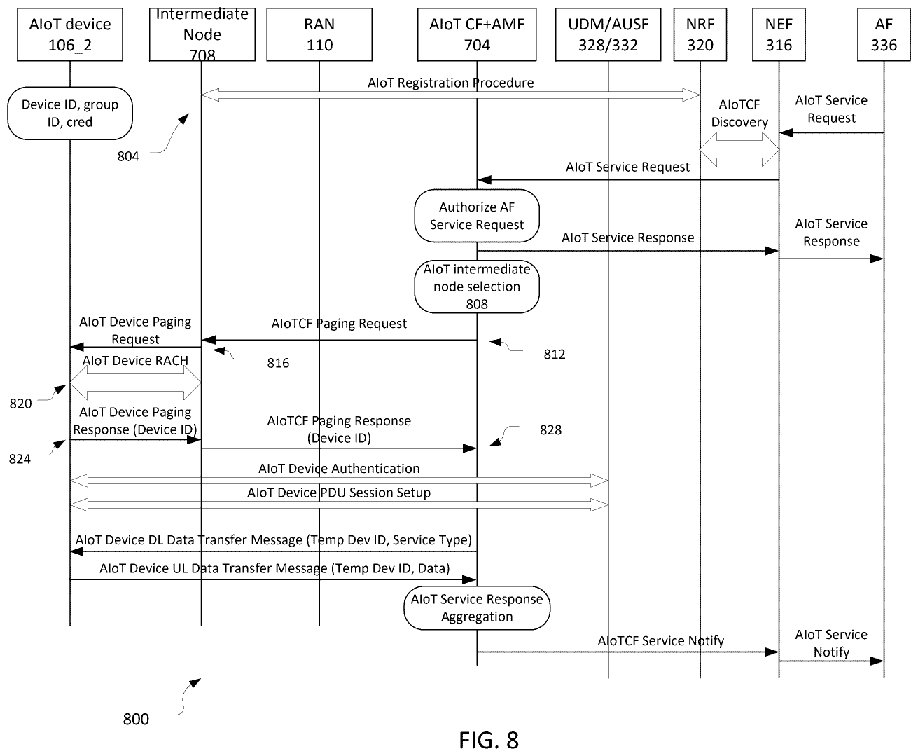

FIG. 8 illustrates a signaling diagram 800 between various components of the network environment 100 in accordance with some embodiments. The signaling diagram 800 may correspond to AIoT service information flow for AIoT 106_2 for topology 2.

The signaling diagram 800 may include operations and signals similar to those described with respect to signaling diagram 600. However, signaling diagram 800 includes intermediate node 708 and operations/signals associated therewith.

The signaling diagram 800 may include, at 804, the intermediate node 708 performing an AIoT registration procedure with the AIoT CF+AMF 704 and the NRF 320. The intermediate node 708 may communicate with several AIoT devices and this registration with the AIoT CF+AMF 704 and the NRF 320 may be independent of communication with any specific AIoT device.

When the AIoT CF+AMF 704 authorizes the AF service request, the signaling diagram 800 may include the AIoT CF+AMF 704 performing an AIoT intermediate node selection at 808. The signaling diagram 800 may include the AIoT CF+AMF 704 generating and sending an AIoT paging request to the intermediate node 708 at 812.

The signaling diagram 800 may further include, at 816, the intermediate node 708 generating and sending an AIoT device paging request. The high-end AIoT device 106_2 may perform an AIoT device RACH procedure at 820 and, subsequently, generate and send an AIoT device paging response message to the intermediate node 708 at 824. The AIoT device paging response message may be generated to include the device ID of the high-end

AIoT device 106_2. The intermediate node 708 may then generate and transmit an AIoT CF paging response to the AIoT CF+AMF 704 at 828. The AIoT CF paging response may include the device ID.

The signaling diagram 800 is described with respect to high-end AIoT device 106_2 for Topology 2; however, in other embodiments, a similar signaling diagram may apply to low-end AIoT device 106_1 for Topology 1 with some adjustments. For example, a signaling diagram similar to that shown and described with respect to FIG. 3 may be used for Topology 2 by including the intermediate node 708 to perform the paging messages and facilitate device transfer between the low-end AIoT device 106_1 and the RAN 110.

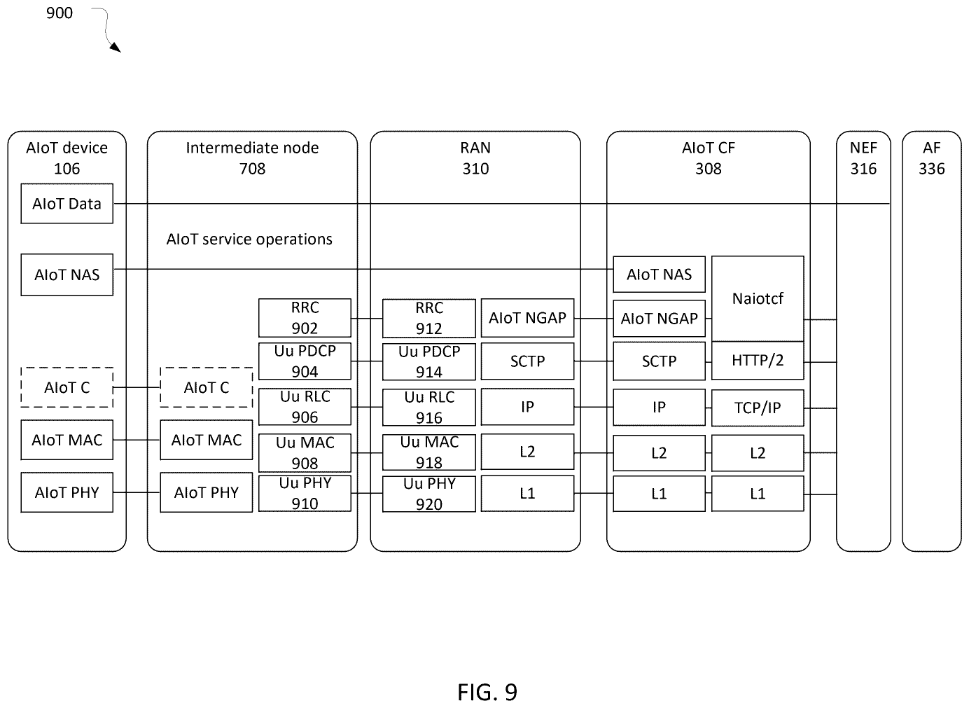

FIG. 9 illustrates control-plane protocol stacks of components of the network environment 100 in accordance with some embodiments. The control-plane protocol stacks of FIG. 9 may be similar to the control-plane protocol stacks of FIG. 4, with like-named protocol layers corresponding to one another. However, the control-plane protocol stacks of FIG. 9 include the intermediate node 708 operating as a reader disposed between the AIoT device 106 and the RAN 310. Protocol layers facilitating communication between AIoT device 106 and intermediate node 708 of FIG. 9 may be similar to protocol layers facilitating communication between AIoT device 106 and reader 304 of FIG. 4. Similarly, protocol layers facilitating communication between RAN 310 and AIoT CF of FIG. 9 may be similar to protocol layers facilitating communication between reader 304 and AIoT CF of FIG. 4.

FIG. 4 also illustrates protocol layers that facilitate communication between the intermediate node 708 and the RAN 310 over, for example, a Uu interface. In particular, intermediate node 708 may include RRC 902, Uu PDCP 904, Uu RLC 906, Uu MAC 908, and Uu PHY 910. The RAN 310 may include RRC 912 communicatively coupled with RRC 902; Uu PDCP 914 communicatively coupled with Uu PDCP 904; Uu RLC 916 communicatively coupled with Uu RLC 906; Uu MAC 918 communicatively coupled with Uu MAC 908; and Uu PHY 920 communicatively coupled with Uu PHY 910.

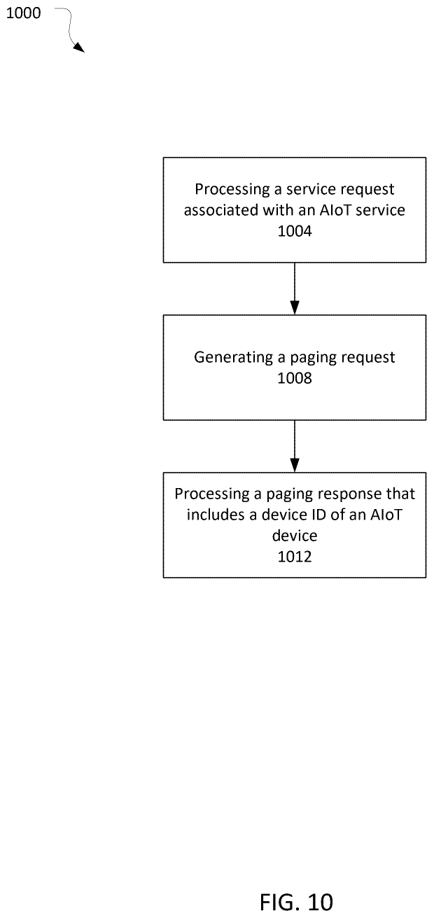

FIG. 10 is an operation flow/algorithmic structure 1000 in accordance with some embodiments. The operation flow/algorithmic structure 1000 may be implemented in, or performed by, a device of the core network 112 such as AIoT CF 308, AIoT CF+AMF 704, network node 1400, or components therein, for example, processors 1404.

The operation flow/algorithmic structure 1000 may include, at 1004, processing a service request associated with an AIoT service. The service request may be associated with the service that is requested by an application function. In some embodiments, the service request may be an AIoT CF service request received from an NEF. The AIoT CF service request may be based on an AIoT service request that the application function provides to the NEF.

The operation flow/algorithmic structure 1000 may further include, at 1008, generating a paging request to be transmitted to a reader. The paging request may be generated based on the received service request. The paging request may be an AIoT CF paging request. In some embodiments, the reader may be identified based on an AIoT registration message the reader previously sent to an AIoT CF. The AIoT registration message may include a reader ID associated with the reader. In some embodiments, the AIoT registration message may be processed by an NGAP layer of the AIoT CF, which is communicatively coupled with an NGAP layer of the reader.

The operation flow/algorithmic structure 1000 may further include, at 1012, processing a paging response that includes a device ID associated with an AIoT device. The AIoT device may be preconfigured with the device ID as described elsewhere herein.

In some embodiments, the paging request may include a service type associated with the service request in the paging response may include data associated with the service type. In other embodiments, the service type and a temporary device ID may be included in a downlink data transfer message and the temporary device ID and data associated with the service type may be included in an uplink data transfer message. The downlink/uplink data transfer messages may be processed by an AIoT NAS layer in an AIoT control function that is communicatively coupled with an AIoT NAS layer in the AIoT device.

In some embodiments, data associated with the service request may be collected from a plurality of uplink data transfer messages. The collected data may be aggregated and forwarded in a service notify message transmitted to an NEF.

In some embodiments, after processing the paging response, the operation flow/algorithmic structure 1000 may include generating a device ID subscription check message to be transmitted to a UDM or AUSF. A response to the check message may be used as a basis for verifying that the AIoT device is enabled, a service area of the AIoT device, or a service operation of the AIoT device. One or more of these received parameters may be saved for later reference. If an integrity of the AIoT device is determined to be compromised, the device ID associated with the AIoT device may be added to a blacklist.

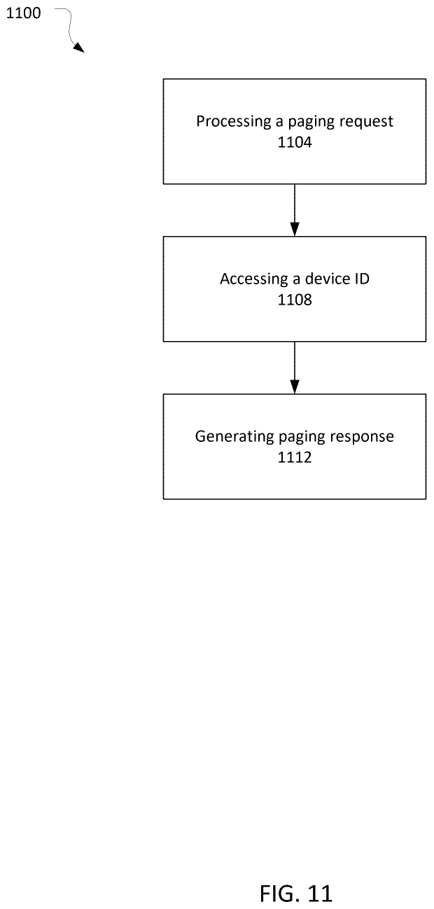

FIG. 11 is an operation flow/algorithmic structure 1100 in accordance with some embodiments. The operation flow/algorithmic structure 1100 may be implemented in, or performed by, AIoT device 116, device 1300, or components therein, for example, processors 1304.

The operation flow/algorithmic structure 1100 may include, at 1104, processing a paging request. The paging request may be associated with the service request transmitted by an application function. In some embodiments, the paging request may include a service type associated with the service request.

The operation flow/algorithmic structure 1100 may further include, at 1108, accessing a device ID. The device ID may be preconfigured on a component of an AIoT device.

The operation flow/algorithmic structure 1100 may further include, at 1112, generating a paging response. The paging response may be generated to include an indication of the device ID. In some embodiments, the paging response may include data associated with the service type.

In some embodiments, a RACH procedure may be performed with an AIoT reader based on processing the paging request. The paging response may be provided for transmission based on the RACH procedure.

In some embodiments, the operation flow/algorithmic structure 1100 may include processing a downlink data transfer message with an indication of a service type; and generating an uplink data transfer message with data associated with the service type. The uplink data transfer message to be transmitted to an AIoT control function. The downlink data transfer message may include a temporary device ID and the uplink data transfer message may include the temporary device ID.

In some embodiments, the operation flow/algorithmic structure 1100 may include performing a registration/authentication procedure and PDU session startup with the network. This may be done when the operation flow/algorithmic structure 1100 is performed by a high-end AIoT device.

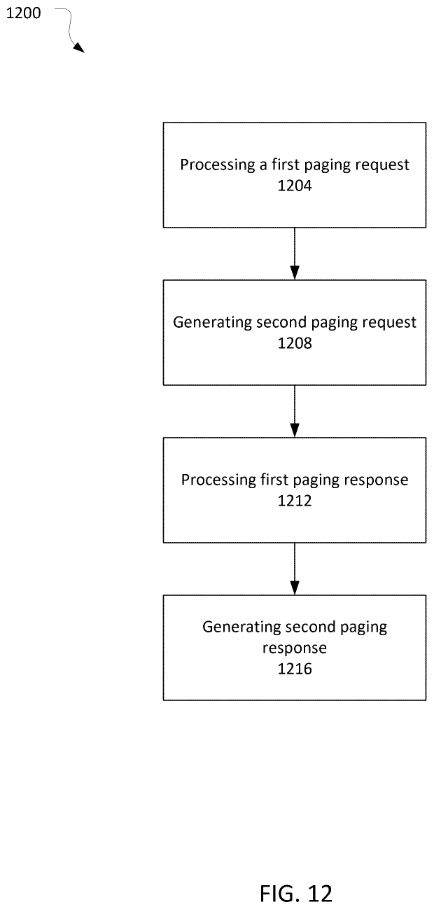

FIG. 12 is an operation flow/algorithmic structure 1200 in accordance with some embodiments. The operation flow/algorithmic structure 1200 may be implemented in, or performed by, a reader such as UE 104, base station 108, reader 304, intermediate node 708, device 1300, network node 1400, or components therein, for example, processors 1304 or 1404.

The operation flow/algorithmic structure 1200 may include, at 1204, processing a first paging request. The first paging request may be an AIoT CF paging request received from an AIoT CF (either directly or through a RAN).

The operation flow/algorithmic structure 1200 may further include, at 1208, generating a second paging request. The second paging request may be an AIoT device paging request that is to be transmitted to an AIoT device.

The operation flow/algorithmic structure 1200 may further include, at 1212, processing a first paging response. The first paging response may be an AIoT device paging response that is received from the AIoT device. The first paging response may include a device ID associated with the AIoT device. The AIoT device may be preconfigured with the device ID.

The operation flow/algorithmic structure 1200 may further include, at 1216, generating a second paging response. The second paging response may be an AIoT CF paging response that is transmitted to the AIoT CF.

In some embodiments, the operation flow/algorithmic structure 1200 may further include performing a RACH procedure with the AIoT device. The first paging response may be received after performing the RACH procedure.

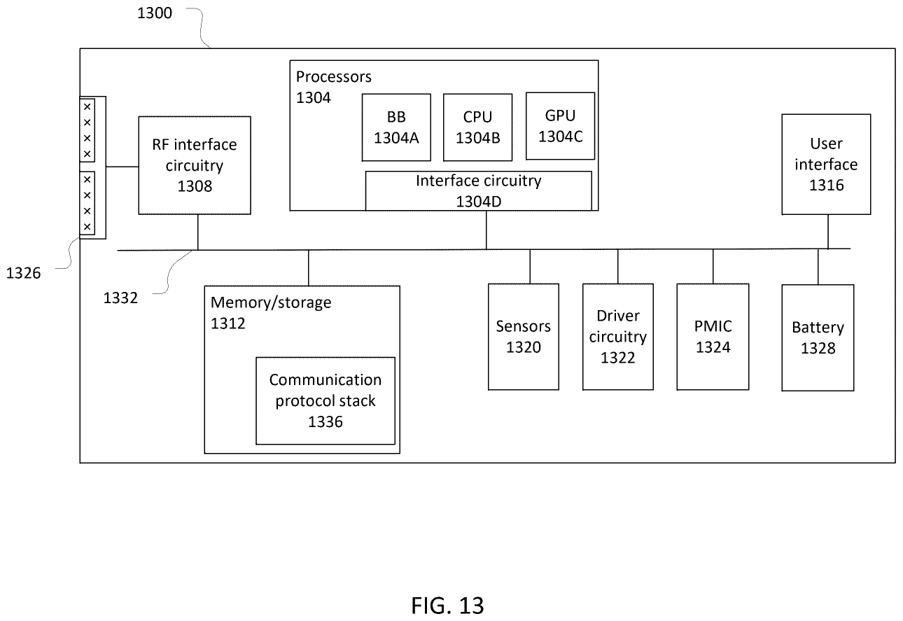

FIG. 13 illustrates a device 1300 in accordance with some embodiments. The device 1300 may be similar to and substantially interchangeable with UE 104 or AIoT device 106.

The device 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The device 1300 may include processors 1304, RF interface circuitry 1308, memory/storage 1312, user interface 1316, sensors 1320, driver circuitry 1322, power management integrated circuit (PMIC) 1324, antenna 1326, and battery 1328. The components of the device 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the device 1300. However, some of the components shown may be omitted, additional components may be present, and different arrangement of the components shown may occur in other implementations.

The components of the device 1300 may be coupled with various other components over one or more interconnects 1332, which may represent any type of interface, input/output, bus (local, system, or expansion), transmission line, trace, or optical connection that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the device 1300 to perform AIoT operations as described herein. The processors 1304 may also include interface circuitry 1304D to communicatively couple the processor circuitry with one or more other components of the device 1300.

In some embodiments, the baseband processor circuitry 1304A may access a communication protocol stack 1336 in the memory/storage 1312 to communicate over a 3GPP compatible network. In general, the baseband processor circuitry 1304A may access the communication protocol stack 1336 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer.

In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that includes instructions (for example, communication protocol stack 1336) that may be executed by one or more of the processors 1304 to cause the device 1300 to perform various delay-adaptive operations described herein.

The memory/storage 1312 includes any type of volatile or non-volatile memory that may be distributed throughout the device 1300. In some embodiments, some of the memory/storage 1312 may be located on the processors 1304 themselves (for example, memory/storage 1312 may be part of a chipset that corresponds to the baseband processor circuitry 1304A), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and a radio frequency front module (RFEM) that allows the device 1300 to communicate with other devices over a radio access network. The RF interface circuitry 1308 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, or phased array antennas. The antenna 1326 may have one or more panels designed for specific frequency bands including bands in FRI or FR2.

The user interface 1316 includes various input/output (I/O) devices designed to enable user interaction with the device 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the device 1300.

The sensors 1320 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1322 may include software and hardware elements that operate to control particular devices that are embedded in the device 1300, attached to the device 1300, or otherwise communicatively coupled with the device 1300. The driver circuitry 1322 may include individual drivers allowing other components to interact with or control various input/output (I/O) devices that may be present within, or connected to, the device 1300. For example, driver circuitry 1322 may include a display driver to control and allow access to a display device, a touchscreen driver to control and allow access to a touchscreen interface, sensor drivers to obtain sensor readings of sensors 1320 and control and allow access to sensors 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the device 1300. In particular, with respect to the processors 1304, the PMIC 1324 may control power-source selection, voltage scaling, battery charging, or DC-to-DC conversion.

A battery 1328 may power the device 1300, although in some examples the device 1300 may be mounted deployed in a fixed location and may have a power supply coupled to an electrical grid. The battery 1328 may be a lithium ion battery, a metal-air battery, such as a zinc-air battery, an aluminum-air battery, a lithium-air battery, and the like.

In some implementations, such as in vehicle-based applications, the battery 1328 may be a typical lead-acid automotive battery.

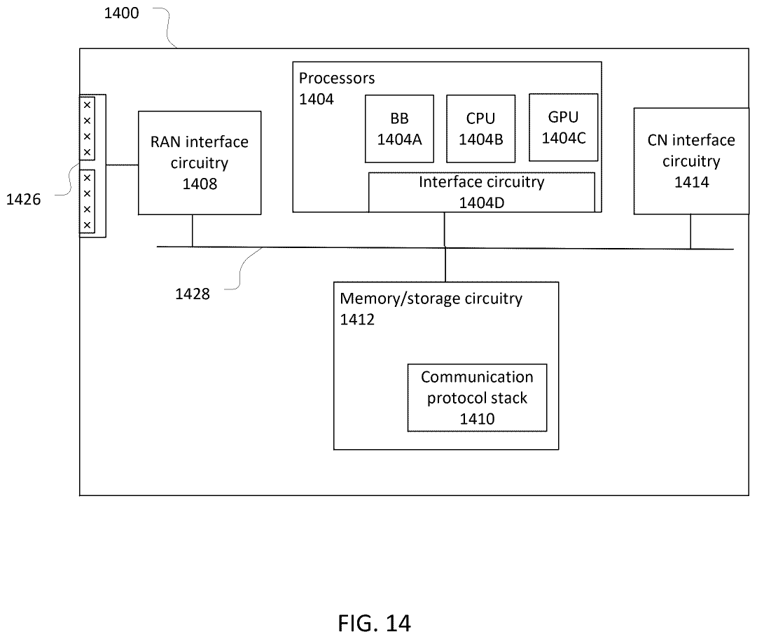

FIG. 14 illustrates a network node 1400 in accordance with some embodiments. The network node 1400 may be similar to and substantially interchangeable with base station 108 or a device of the core network 112 or external data network 140.

The network node 1400 may include processors 1404, RF interface circuitry 1408 (if implemented as a base station), core network (CN) interface circuitry 1414, memory/storage circuitry 1412, and antenna structure 1426.

The components of the network node 1400 may be coupled with various other components over one or more interconnects 1428.

The processors 1404, RF interface circuitry 1408, memory/storage circuitry 1412 (including communication protocol stack 1410), antenna structure 1426, and interconnects 1428 may be similar to like-named elements shown and described with respect to FIG. 13.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage circuitry 1412 to cause the network node 1400 to perform AIoT operations as described herein. The processors 1404 may also include interface circuitry 1404D to communicatively couple the processor circuitry with one or more other components of the network node 1400.

The CN interface circuitry 1414 may provide connectivity to a core network, for example, a 5th Generation Core network (5GC) using a 5GC-compatible network interface protocol such as carrier Ethernet protocols, or some other suitable protocol. Network connectivity may be provided to/from the network node 1400 via a fiber optic or wireless backhaul. The CN interface circuitry 1414 may include one or more dedicated processors or FPGAs to communicate using one or more of the aforementioned protocols. In some implementations, the CN interface circuitry 1414 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: processing a service request associated with an ambient internet of things (AIoT) service, the service request associated with a service requested by an application function; generating a paging request based on the service request, the paging request to be transmitted to a reader; processing a paging response received from the reader, the paging response to include an indication of a device identifier (ID) associated with an AIoT device, wherein the AIoT device is preconfigured with the device ID.

Example 2 includes a method of example 1 or some other example herein, further comprising: processing a registration message received from the reader, wherein the registration message includes a reader ID associated with the reader.

Example 3 includes method of example 2 or some other example herein, further comprising: processing the registration message with a next generation application protocol (NGAP) layer of an AIoT control function that is communicatively coupled with a

NGAP layer of the reader.

Example 4 includes the method of example 1 or some other example herein, further comprising: authorizing the service request; and generating a service response to provide an indication of said authorizing of the service request, the service response to be transmitted to a network exposure function.

Example 5 includes a method of example 1 or some other example herein, further comprising: generating a device ID subscription check message to be transmitted to a unified data management (UDM) or an authentication server function (AUSF); and processing a response to the device ID subscription check message received from the UDM or AUSF.

Example 6 includes the method of example 5 or some other example herein, further comprising: verifying, based on the response, that the AIoT device is enabled; a service area of the AIoT device; or a service operation of the AIoT device.

Example 7 includes a method of example 5 or some other example herein, further comprising: determining, based on the response, an integrity of the AIoT device is compromised; and adding the device ID to a blacklist based on determining the integrity is compromised.

Example 8 includes the method of example 1 or some other example herein, wherein the paging request includes a service type associated with the service request and the paging response includes data associated with the service type.

Example 9 includes the method of example 1 or some other example herein, further comprising: providing, for transmission to the AIoT device, a downlink data transfer message with an indication of a service type associated with the service request; and processing an uplink data transfer message received from the AIoT device, the uplink data transfer message to include data associated with the service type.

Example 10 includes the method of example 9 or some other example herein, further comprising: generating a temporary device ID, wherein the downlink data transfer message and the uplink data transfer message both include the temporary device ID.

Example 11 includes the method of example 9 or some other example herein, further comprising: processing the uplink data transfer message at an AIoT non-access stratum (NAS) layer in an AIoT control function that is communicatively coupled with an AIoT NAS layer in the AIoT device.

Example 12 includes the method of example 9 or some other example herein, further comprising: processing a plurality of uplink data transfer messages received from a plurality of AIoT devices; and generating an AIoT controller function (CF) service notify message to include data aggregated from the plurality of uplink data transfer messages, the AIoT CF service notify message to be transmitted to a network exposure function.

Example 13 includes the method of example 1 or some other example herein, wherein the AIoT device is a low-end AIoT device, a type 1 AIoT device, or a type 2 AIoT device.

Example 14 includes the method of example 1 or some other example herein, wherein the reader is a base station or an intermediate node.

Example 15 includes a method comprising: processing a paging request, wherein the paging request is associated with a service request transmitted by an application function; accessing a device identifier (ID) preconfigured on a component of an ambient Internet of things (AIoT) device; and generating a paging response to be transmitted in response to the paging request, the paging response to include an indication of the device ID.

Example 16 includes the method of example 15 or some other example herein, further comprising: performing a random access channel (RACH) procedure with an AIoT reader based on processing the paging request; and providing the paging response for transmission based on the RACH procedure.

Example 17 includes the method of example 15 or some other example herein, wherein the paging request includes a service type associated with the service request and the paging response includes data associated with the service type.

Example 18 includes the method of example 15 or some other example herein, further comprising: processing a downlink data transfer message with an indication of a service type; and generating an uplink data transfer message with data associated with the service type, the uplink data transfer message to be transmitted to an AIoT control function.

Example 19 includes the method of example 18 or some other example herein, wherein the downlink data transfer message includes a temporary device ID and generating the uplink data transfer message includes: generating the uplink data transfer message to include the temporary device ID.

Example 20 includes the method of example 15 or some other example herein, further comprising: performing an authentication procedure with one or more network components.

Example 21 includes the method of example 20 or some other example herein, further comprising: performing a PDU session setup after performing the authentication procedure.

Example 22 includes the method of example 15 or some other example herein, further comprising: generating a registration request message to be transmitted to an AIoT controller function (CF), the registration request message to include an indication that the AIoT device supports AIoT services; and processing a registration accept message received from the AIoT CF, the registration accept message to indicate whether the AIoT device is authorized to perform an AIoT operation.

Example 23 includes a method comprising: processing a first paging request received from an ambient Internet of things (AIoT) controller function (CF); generating a second paging request to be transmitted to an AIoT device; processing a first paging response received from the AIoT device, the first paging response to include an indication of a device identifier (ID) associated with the AIoT device, wherein the AIoT device is preconfigured with the device ID; and generating a second paging response to be transmitted to the AIoT CF, the second paging response to include the device ID.

Example 24 includes the method of example 23 or some other example herein, further comprising: performing a random access channel procedure with the AIoT device.

Example 25 includes the method of example 23 or some other example herein, wherein the method is performed by a component of an intermediate node or a base station.

Another example may include an apparatus comprising means to perform one or more elements of a method described in or related to any of examples 1-25, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-25, or any other method or process described herein.

Another example may include an apparatus comprising logic, modules, or circuitry to perform one or more elements of a method described in or related to any of examples 1-25, or any other method or process described herein.

Another example may include a method, technique, or process as described in or related to any of examples 1-25, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-25, or portions thereof.

Another example may include a signal as described in or related to any of examples 1-25, or portions or parts thereof.

Another example may include a datagram, information element, packet, frame, segment, PDU, or message as described in or related to any of examples 1-25, or portions or parts thereof, or otherwise described in the present disclosure.

Another example may include a signal encoded with data as described in or related to any of examples 1-25, or portions or parts thereof, or otherwise described in the present disclosure.

Another example may include a signal encoded with a datagram, IE, packet, frame, segment, PDU, or message as described in or related to any of examples 1-25, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-25, or portions thereof.

Another example may include a computer program comprising instructions, wherein execution of the program by a processing element is to cause the processing element to carry out the method, techniques, or process as described in or related to any of examples 1-25, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a service request associated with an ambient internet of things (AIoT) service, the service request associated with a service requested by an application function;
generating a paging request based on the service request, the paging request to be transmitted to a reader; and
processing a paging response received from the reader, the paging response to include an indication of a device identifier (ID) associated with an AIoT device, wherein the AIoT device is preconfigured with the device ID.

2. The method of claim 1, further comprising:
processing a registration message received from the reader, wherein the registration message includes a reader ID associated with the reader.

3. The method of claim 2, further comprising:
processing the registration message with a next generation application protocol (NGAP) layer of an AIoT control function that is communicatively coupled with a NGAP layer of the reader.

4. The method of claim 1, further comprising:
authorizing the service request; and
generating a service response to provide an indication of said authorizing of the service request, the service response to be transmitted to a network exposure function.

5. The method of claim 1, further comprising:
generating a device ID subscription check message to be transmitted to a unified data management (UDM) or an authentication server function (AUSF); and
processing a response to the device ID subscription check message received from the UDM or AUSF.

6. The method of claim 5, further comprising:
verifying, based on the response, that the AIoT device is enabled; a service area of the AIoT device; or a service operation of the AIoT device.

7. The method of claim 5, further comprising:
determining, based on the response, an integrity of the AIoT device is compromised; and
adding the device ID to a blacklist based on determining the integrity is compromised.

8. The method of claim 1, wherein the paging request includes a service type associated with the service request and the paging response includes data associated with the service type.

9. The method of claim 1, further comprising:
providing, for transmission to the AIoT device, a downlink data transfer message with an indication of a service type associated with the service request; and
processing an uplink data transfer message received from the AIoT device, the uplink data transfer message to include data associated with the service type.

10. The method of claim 1, wherein the AIoT device is a low-end AIoT device, a type 1 AIoT device, or a type 2 AIoT device.

11. The method of claim 1, wherein the reader is a base station or an intermediate node.

12. A method comprising:
processing a paging request, wherein the paging request is associated with a service request transmitted by an application function;
accessing a device identifier (ID) preconfigured on a component of an ambient Internet of things (AIoT) device; and
generating a paging response to be transmitted in response to the paging request, the paging response to include an indication of the device ID.

13. The method of claim 12, further comprising:
performing a random access channel (RACH) procedure with an AIoT reader based on processing the paging request; and
providing the paging response for transmission based on the RACH procedure.

14. The method of claim 12, wherein the paging request includes a service type associated with the service request and the paging response includes data associated with the service type.

15. The method of claim 12, further comprising:
processing a downlink data transfer message with an indication of a service type; and
generating an uplink data transfer message with data associated with the service type, the uplink data transfer message to be transmitted to an AIoT control function.

16. The method of claim 15, wherein the downlink data transfer message includes a temporary device ID and generating the uplink data transfer message includes:
generating the uplink data transfer message to include the temporary device ID.

17. The method of claim 12, further comprising:
performing an authentication procedure with one or more network components; and
performing a PDU session setup after performing the authentication procedure.

18. The method of claim 12, further comprising:
generating a registration request message to be transmitted to an AIoT controller function (CF), the registration request message to include an indication that the AIoT device supports AIoT services; and
processing a registration accept message received from the AIoT CF, the registration accept message to indicate whether the AIoT device is authorized to perform an AIoT operation.

19. One or more non-transitory, computer-readable media having instructions that, when executed, cause processor circuitry to:
process a first paging request received from an ambient Internet of things (AIoT) controller function (CF);
generate a second paging request to be transmitted to an AIoT device;
process a first paging response received from the AIoT device, the first paging response to include an indication of a device identifier (ID) associated with the AIoT device, wherein the AIoT device is preconfigured with the device ID; and
generate a second paging response to be transmitted to the AIoT CF, the second paging response to include the device ID.

20. The one or more non-transitory, computer-readable media of claim 19, wherein the instructions, when executed, further cause the processor circuitry to:
perform a random access channel procedure with the AIoT device.
